(19) United States
(12) Patent Application Publication
(10) Pub. No.: US 2021/0166531 A1
(43) Pub. Date: Jun. 3, 2021

(54) ANTI-THEFT ATM CASING

(71) Applicant: EMSN INITIATIVE AND RESOLUTIONS 2013 LTD., LOD (IL)

(72) Inventors: Shmuel NEUFELD, Lod (IL); Elazar MEDIZINSKI, Neta (IL); Omer LEVI, Lod (IL); Harel OBERMAN, Efrat (IL)

(21) Appl. No.: 17/174,779

(22) Filed: Feb. 12, 2021

Related U.S. Application Data
(63) Continuation-in-part of application No. 16/101,578, filed on Aug. 13, 2018, now Pat. No. 10,968,680.

(51) Int. Cl. G07F 19/00; E05G 1/024

(52) U.S. Cl. CPC G07F 19/205; E05G 1/024

(57) ABSTRACT

An anti-theft ATM casing including casing panels configured to surround both sides, front and rear of the ATM and to lock the ATM therein. At least one of the casing panels includes an anchoring flange and a plurality of casing anchor bolts to secure the ATM casing to the ground. The anchoring flange(s) extend from a bottom portion of at least one of the panels and include an anchoring flange cover, configured to prevent access to the plurality of casing anchor bolts.

### CROSS REFERENCE TO RELATED APPLICATIONS

This application is a Continuation in Part of U.S. Ser. No. 16/101,578, entitled “Modular Armor”, and filed 13 Aug. 2018, the contents of which are hereby incorporated by reference.

### FIELD OF THE INVENTION

The present invention relates to anti-theft devices, in particular a device to prevent theft of and tampering with Automatic Teller Machines (ATMs), vending machines and the like.

### BACKGROUND OF THE INVENTION

ATM machines, vending machines and the like are targets for thieves intending to steal cash stored therein. In order to prevent such tampering, ATM's and vending machines are typically at least partially encased in a casing or protective armor.

### SUMMARY OF THE INVENTION

The present invention relates to armor and an anti-theft casing for an ATM.

Embodiments of one aspect of the invention provide modular armor for an ATM. The armor includes a rear modular armored panel including a first rear lateral edge, a second rear lateral edge and a rear bottom edge, where multiple lateral connectors are disposed on the first rear lateral edge and on the second rear lateral edge. The rear modular armored panel further includes a rear bottom extension extending from the rear bottom edge, a first side modular armored panel including a first side rear extension extends from a first side rear edge of the first side modular armored panel, The first side rear extension includes multiple apertures designed to receive multiple lateral connectors disposed on the first rear lateral edge, and a first side bottom extension extends from a first side bottom edge of the first side modular armored panel. At least one aperture is designed to receive a ground connector disposed in the first side bottom extension. A second side modular armored panel includes a second side rear extension extending from a second side rear edge of the second side modular armored panel, and the second side rear extension includes multiple apertures designed to receive multiple lateral connectors disposed on the second rear lateral edge. A second side bottom extension extends from a second side bottom edge of the second side modular armored panel, where at least one aperture is designed to receive a ground connector disposed in the second side bottom extension. A base modular armored panel includes a first intermediate platform including a first intermediate proximal edge, where at least one aperture designed to receive a ground connector is disposed on the first intermediate platform, and where a first remote perpendicular wall extends vertically upwards from the first intermediate proximal edge, a first elevated platform including a first elevated remote edge and a first elevated proximal edge, where the first elevated platform is connected to the first remote perpendicular wall at the first elevated remote edge, and where a first proximal perpendicular wall extends vertically downward from the first intermediate proximal edge thereof, a central platform including a first central lateral edge and a second central lateral edge, where the central platform is connected to the first proximal perpendicular wall at the first central lateral edge thereof and where a second proximal perpendicular wall extends vertically upwards from the second central lateral edge thereof, a second elevated platform including a second elevated remote edge and a second elevated proximal edge, where the second elevated platform is connected to the second proximal perpendicular wall at the second elevated proximal edge thereof, and where the second remote perpendicular wall extends vertically downward from the second elevated remote edge thereof, and a second intermediate platform including a second intermediate proximal edge, where at least one aperture designed to receive a ground connector is disposed on the second intermediate platform, and where the second intermediate platform is connected to the second remote perpendicular wall at the second intermediate proximal edge thereof, a front modular armored panel including a first side front extension configured to be rotatably connected to the first side modular armored panel, and a second side front extension configured to be releasably secured to the second side modular armored by a locking element, where the modular armor includes at least one ground connector designed to be threaded through the at least one aperture in the first intermediate platform, the at least one aperture in the bottom extension of the first side modular armored panel and into the ground, and at least one ground connector designed to be threaded through the second intermediate platform, the bottom extension of the second side modular armored panel and into the ground.

The term “ATM” as noted herein refers to Automated Teller Machines (ATMs), vending machines, arcade machines, and other such devices that store money or goods and may benefit from additional protection against tampering.

Embodiments of another aspect of the invention relate to an anti-theft ATM casing with panels configured to surround both sides, front and rear of the ATM and to lock the ATM therein. At least one of the casing panels includes an anchoring flange and a plurality of casing anchor bolts to secure the ATM casing to the ground. The anchoring flange(s) extend from a bottom portion of at least one of the panels and include an anchoring flange cover, configured to prevent access to the plurality of casing anchor bolts.

More specifically, the anti-theft ATM casing includes casing panels including a front panel; a rear panel; a right side panel; and a left side panel, wherein the rear panel has a right lateral edge and a left lateral edge; the right side panel has a rear lateral edge; the left side panel has a rear lateral edge; and the front panel has a right lateral edge configured to pivotably connect to the right lateral edge of the right side panel; and the front panel has a left lateral edge configured to reversibly and lockably connect with the left lateral forward edge of the left side panel. The panels have lateral connectors (a) disposed at the right lateral edge of the rear panel and at the rear lateral edge of the right side panel, and which correspond to and are configured to reversibly connect there-between; and (b) disposed at the left lateral edge of the rear panel and at the rear lateral edge of the left side panel, which correspond to and are configured to reversibly connect there-between. Locking elements are disposed at the left lateral edge of the front panel and at the front lateral edge of the left side panel to facilitate locking there-between; and a plurality of casing anchor bolts are configured to secure the ATM casing to the ground. At least one of (i) the rear panel, (ii) the right side panel; and (iii) the left side panel includes an ATM casing anchoring mechanism including an anchoring flange extending from a bottom portion of at least one of (i) the rear panel, (ii) the right side panel; and (iii) the left side panel and configured to receive the plurality of casing anchoring bolts. The anchoring flange includes an anchoring flange cover, configured to prevent access to the plurality of casing anchor bolts.

In some embodiments, the ATM casing anchoring mechanism is integrally formed with at least one of the rear panel, the right side panel; and the left side panel. In some embodiments, the anchoring flange is integrally formed with at least one of (i) the rear panel, (ii) the right side panel; and (iii) the left side panel. In some embodiments, the anchoring flange is integrally formed with the right side panel; and (iii) the left side panel.

In some embodiments, the front panel and a forward portion of the right side panel each comprises a recess configured to house corresponding portions of the locking elements.

In some embodiments, at least one of (i) the rear panel, (ii) the right side panel; and (iii) the left side panel comprises an inner wall and an outer wall with a hollow space there-between. In some embodiments, within at least one hollow space there is located at least one of reinforcement plank.

In some embodiments, within at least one hollow space there is at least one plank is associated with, or attached to, one or more of the panels via one or more plank holders. In some embodiments, the planks are disposed between spaced apart the plank holders in a plank receiving space.

Potential advantages of some embodiments include that the ATM anti-theft casing can be installed in an ATM fixed to the ground; and the casing is easily assembled/installed.

### BRIEF DESCRIPTION OF THE DRAWINGS

The invention may be more dearly understood upon reading of the following detailed description of non-limiting exemplary embodiments thereof, with reference to the following drawings, in which:

FIG. 1 is a perspective view of a typical ATM.

FIG. 2 is a perspective view of modular armor, according to embodiments of the present invention, with an ATM positioned within.

FIGS. 3-6 are perspective views of modular armored panels, respectively, a rear panel, a first side panel, a second side panel, and a base panel, of the modular armor, according to embodiments of the present invention.

FIG. 7 is a perspective view of the base panel installed on bottom extensions of the side panels and the rear panel, according to embodiments of the invention.

FIG. 8 is a perspective view of a front modular armored panel of the modular armor, according to embodiments of the invention.

FIG. 9 is a flowchart showing a method for assembling the modular armor, according to embodiments of the present invention.

FIG. 10 is a perspective view of an anti-theft casing for an ATM, of the present invention, in accordance with embodiments thereof.

FIG. 11 is a perspective view of the anti-theft casing installed around an ATM.

FIG. 12 is a perspective exploded view of a side panel of the ATM anti-theft casing, according to embodiments of the present invention.

FIGS. 13A-13C show detailed views of an embodiment of an anchoring mechanism of the present ATM anti-theft casing.

The following detailed description of embodiments of the invention refers to the accompanying drawings referred to above. Dimensions of components and features shown in the figures are chosen for convenience or clarity of presentation and are not necessarily shown to scale. Wherever possible, the same or similar reference numbers will be used throughout the drawings and the following description to refer to the same and similar parts.

### DETAILED DESCRIPTION OF EMBODIMENTS

Illustrative embodiments of the invention are described below. In the interest of clarity, not all features/components of an actual implementation are necessarily described.

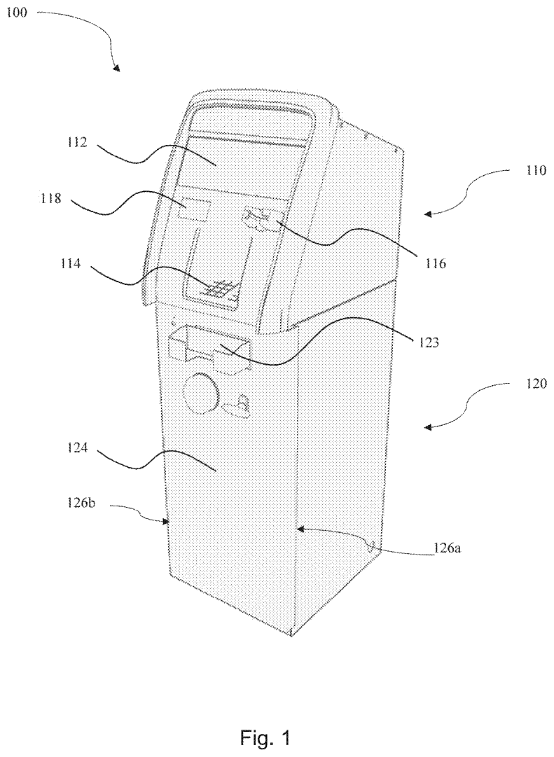

FIG. 1 shows a typical prior art ATM 100 including two major portions: an interface portion 110 configured to be accessible to a user, and a safe portion 120, which should be inaccessible to users and accessible to operators. Interface portion 110 typically includes components that enable users to interact with ATM 100 in order to perform financial transactions. In most cases, interface portion 110 communicates with a computer (not shown) located inside ATM 100. The computer is connected to a display 112 for presenting information to the user; a keypad 114 (or “touch” display) for enabling the user to enter a pin code and other such information; a card reader 116 enabling the user to insert or swipe a magnetic card; and a printer 118 for printing transaction receipts. Interface portion 110 may include other components, such as cameras, power supplies, speakers, and the like.

Safe portion 120 includes a safe and a cash distributing mechanism 123 disposed on a front surface thereof, for dispensing cash stored in the safe to users. Safe portion 120 further includes a safe door 124, located on a front side thereof, which generally has a hinged side 126a and a safe door opening side 126a opposite to the hinged side. In some cases, safe door 124 serves as the primary target for the tampering, since the safe door is vulnerable to various forms of attack. For example, a vertical seam (not shown) disposed at safe door opening side 126b of safe door 124 is a common and vulnerable location for attacks, for example, by a crowbar applying brute force on safe door 124 to fold the safe door or to crack the safe door's lock(s). A plurality of holes (not shown) are commonly drilled through a bottom surface of safe portion 120 may include a plurality of holes to allow ground connectors such as anchor bolts to be accommodated therein, for securing ATM 100 to a solid base or the ground to prevent removal of the ATM.

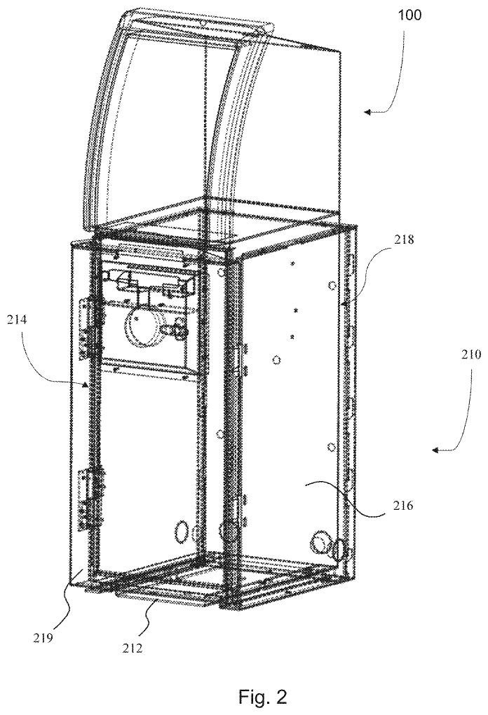

FIG. 2 shows ATM 100 positioned within modular armor 210, according to embodiments of the invention. Modular armor 210 is configured to provide at least a portion of ATM 100 with protection from tampering. Such tampering may include drilling, applying blunt force, cutting and so on.

In some embodiments, modular armor 210 includes a plurality of modular armored panels that are connected directly or operably to each other and are secured by a base modular armored panel 212. The modular armored panels of modular armor 210 may be formed of the same or various materials, thickness, and dimensions. In some embodiments, modular armor 210 is designed to closely encase ATM 100 so as to prevent excessive vacant space inside the armor, which may ease tampering with the modular armored panels of modular armor 210. In some embodiments, the modular armored panels of modular armor 210 include a first side modular armored panel 214, a second side modular armored panel 216 and a rear modular armored panel 218. Additionally, modular armor 210 further includes an openable front modular armored panel 219, which is configured to be openable for enabling ATM 100 to be inserted the modular armor and further configured to be closed and locked, for securing the ATM therein.

In some cases, modular armor 210 is box-shaped, wherein first side modular armored panel 214 is parallel to second side modular armored panel 216. Additionally, both first and second side modular armored panels 214 and 216 may be perpendicular to front modular armored panel 219 and to rear modular armored panel 218. In some embodiments, front modular armored panel 219 and rear modular armored panel 218 are parallel to each other.

In some embodiments, at least some of the modular armored panels have the same predetermined height. In some cases, the predetermined height is at least as high as the top surface of the safe portion of ATM 100. In further embodiments, the at least some of the modular armored panels may extend upwards, above the interface portion of ATM 100. In yet another embodiment of the invention, additional extension modular armored panels may be connected on top of the modular armored panels. In such cases, the extension modular armored panels may surround the interface portion of ATM 100.

In some embodiments, modular armor 210 is be formed from various types of steel, such as plate steel, stainless steel, and abrasion-resistant (AR) plate steel. In some embodiments, at least one of the modular armored panels is formed of a single sheet of metal, folded to form its final shape. Folding the metal plates is both cheaper and more durable than welding. In some embodiments, modular armor 210 is made only with folded metal panels and without any welds.

In some embodiments, the weight of modular armor 210 is below 100 Kg, including all the modular armored panels 214, 216, 218, and 219, as well as base modular armored panel 212. In some embodiments, the weight of the entire modular armor is in the range of 50-80 Kgs. In some embodiments, the weight of modular armor 210 enables the modular armor to be shipped by air. Thus, the shipping costs for the modular armor may be low due to the low weight. Additionally, when modular armor 210 is shipped, modular armored panels 214, 216, 218, and 219 may be placed one on top of the other, creating an efficient package that occupies less space than pre-fabricated armor.

Rear modular armored panel 218 is designed to be placed vertically to the ground. In some embodiments, rear modular armored panel 218 is designed to be placed adjacent to a wall. In some embodiments, rear modular armored panel 218 includes a rear inner surface 301, a rear outer surface 302, a first rear lateral edge 303, a second rear lateral edge 304, a rear top edge 305 and a rear bottom edge 306. In some embodiments, there are a plurality of rear holes 320, 321, 322, 323 and 324 in rear modular armored panel 218 for allowing one or more connectors to pass therethrough and be accommodated therein. The connectors may be used for securing rear modular armored panel 218 to a surface, such as a wall, located behind the rear modular armored panel. In some embodiments, rear modular armored panel 218 includes one or more apertures 315 to allow cables to pass from within modular armor 210 to a power source or other plugs located outside the modular armor.

In some embodiments, a rear bottom extension 307 protrudes from rear bottom edge 306 of rear modular armored panel 218. In some cases, rear bottom extension 307 is L-shaped. Rear bottom extension 307 may protrude horizontally from rear inner surface 301 of rear modular armored panel 218 and is configured to be secured to base modular armored panel 212. In some embodiments, rear bottom extension 307 protrudes from the entire length of rear bottom edge 306 of rear modular armored panel 218. In some embodiments, rear bottom extension 307 includes a rear bottom protrusion element 308 and a rear bottom perpendicular element 309. In some cases, rear bottom protrusion element 308 extends perpendicularly to rear modular armored panel 218, for example forwards, and adjacent to the ground. Rear bottom perpendicular element 309 may extend substantially perpendicularly upwards from a distal edge of rear bottom protrusion element 308 and upwards. In some embodiments, rear bottom perpendicular element 309 is perpendicular to rear inner surface 301 of rear modular armored panel 218. The dimensions marked as X and Y (the width of rear bottom protrusion element 308; and the height of rear bottom perpendicular element 309) are determined by the manufacturer/purchaser of the modular armor and may vary between models of the modular armor in accordance with the manufacturing capabilities and/or models.

In some embodiments, a plurality of rear lateral connectors is disposed on first and second lateral edges 303, 304 of rear modular armored panel 218. The connectors, for example the rear lateral connectors, may be L-shaped. In some embodiments, there are first side rear lateral connectors 310a disposed on first rear lateral edge 303 and second side rear lateral connectors 310b disposed on second rear lateral edge 304 of rear modular armored panel 218. In some embodiments, rear lateral connectors 310a and 310b are flush on the same plane of rear modular armored panel 218 and may have the same thickness. Rear lateral connectors 310a and 310b may be formed from a rear horizontal arm 311 and a rear vertical arm 312. In some embodiments, rear horizontal arm 311 extends vertically/laterally outward from the lateral sides of rear modular armored panel 218. In some embodiments, rear vertical arm 312 extends perpendicularly to rear horizontal arm 311 from a distal edge thereof. In some embodiments, rear vertical arm 312 and at least a portion of rear horizontal arm 311 are designed to enter an aperture located on the side modular armored panels (not shown). In such cases, rear lateral connectors 310a and 310b are used to connect side modular armored panels 214 and 216 to rear modular armored panel 218. In some embodiments, first side rear lateral connector 310a faces downward, such that rear vertical arm 312 of each of first side rear lateral connectors 310a extends perpendicularly downwards toward rear bottom edge 306. In some embodiments, second side rear lateral connectors 310b face upward, such that rear vertical arm 312 of each of second side rear lateral connectors 310b extends perpendicularly upward toward rear top edge 305. The vertical flip of the vertical arms of lateral connectors 310a and 310b is configured to ease the assembly of modular armor 218. In some embodiments, first side and second side rear lateral connectors 310a and 310b are equally spaced along the first and second edges of rear modular armored panel 218.

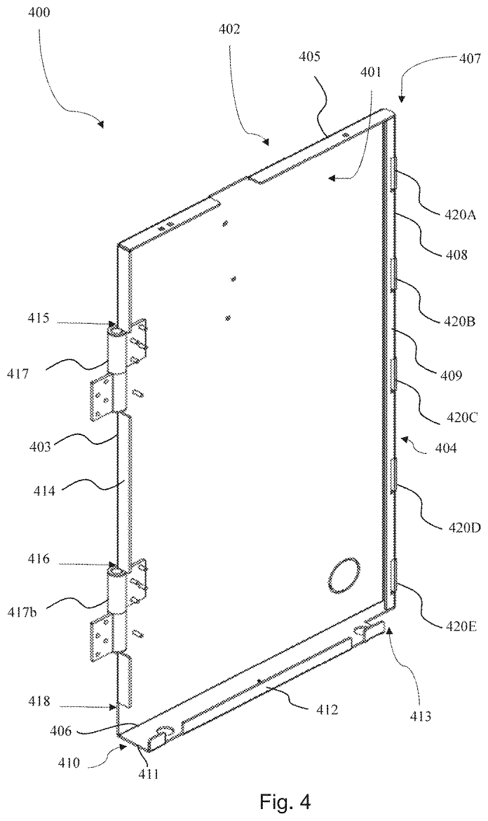

FIG. 4 shows a first side modular armored panel 400 of modular armor 218, which is designed to be placed vertically to the ground. In some embodiments, first side modular armored panel 400 includes a first side inner surface 401, a first side outer surface 402, a first side forward edge 403, a first side rear edge 404, a first side top edge 405 and a first side bottom edge 406. In some embodiments, first side rear edge 404 includes a first side rear extension 407; and first side bottom edge 406 includes a first side bottom extension 410.

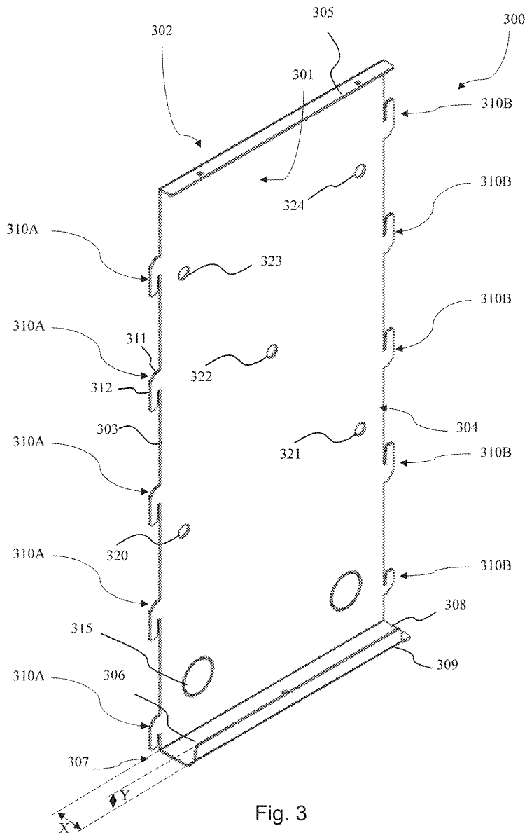

In some embodiments, first side rear extension 407 protrudes from the entire length of first side rear edge 404 of first side modular armored panel 400 and from first side inner surface 401 thereof. First side rear extension 407 includes a first side rear protrusion element 408 and a first side rear perpendicular element 409. First side rear protrusion element 408 extends from first side inner surface 401 of first side modular armored panel 400 and at first side rear edge 404 thereof in a perpendicular manner. In some embodiments, first side rear protrusion element 408 extends to a predefined distance from first side modular armored panel 400, which is slightly larger than the size of the lateral connectors 310a disposed on a first side of rear modular armored panel 218 (300 in FIG. 3). First side rear perpendicular element 409 extends perpendicularly from a distal edge of first side rear protrusion element 408 and towards first side forward edge 403. In some embodiments, first side rear perpendicular element 409 extends to a predefined distance from first side rear protrusion element 408, which is slightly larger than the width of the lateral connectors 310a disposed on the first side of rear modular armored panel 218.

In some embodiments, a plurality of first side apertures 420a-420e is vertically distributed along the length of first side rear perpendicular element 409. First side apertures 420a-420e are configured to receive therethrough a vertical arm and at least a portion of a horizontal arm of the lateral connectors (not shown), which are connected to a rear modular armored panel (not visible). Thus, first side apertures 420a-420e enable connecting first side modular armored panel 400 with rear modular armored panel 300. In some embodiments, first side apertures 420a-420e are designed as elongated rectangles. In some embodiments, first side apertures 420a-420e are shaped similarly to a vertical cross section of lateral connectors 310a, 310b. In some embodiments, first side apertures 420a-420e are equally spaced along first side rear perpendicular element 409.

In some embodiments, first side bottom extension 410 protrudes from first side bottom edge 406 of first side modular armored panel 400. Additionally, first side bottom extension 410 extends horizontally from first side inner surface 401 of first side modular armored panel 400 and is configured to be adjacently situated on the ground below modular armor 210. In some embodiments, first side bottom extension 410 includes a first side bottom protrusion element 411 and a first side bottom perpendicular element 412. First side bottom protrusion element 411 extends perpendicularly to first side modular armored panel 400 and substantially parallel to the ground. In some embodiments, first side bottom protrusion element 411 includes a squared recess in a first side distal rear corner 413 thereof. The squared recess may be designed to house at least a portion of bottom protrusion element 411 of the rear modular armored panel 218. First side bottom perpendicular element 412 extends substantially perpendicularly upwards from a distal edge of first side bottom protrusion element 411 and towards first side top edge 405. In some embodiments, first side bottom perpendicular element 412 is parallel to first side inner surface 401 of first side modular armored panel 400. In some cases, the dimensions of first side bottom extension 410 are identical to the dimensions of the bottom extension of rear modular armored panel 218, as aforementioned in FIG. 3.

In some embodiments, first side forward edge 403 of first side modular armored panel 400 includes a first side front perpendicular element 414. First side front perpendicular element 414 may extend in a perpendicular manner from first side inner surface 401 of first side modular armored panel 400 and at first side front edge 403 thereof. In some embodiments, first side front perpendicular element 414 includes at least one front recess along the length thereof. In some embodiments, first side front perpendicular element 414 includes at least a front upper recess 415, a front intermediate recess 416 and a front lower recess 418. In some embodiments, upper front recess 415 and intermediate front recess 416 are configured to contain hinges 417a and 417b, respectively, where those hinges are configured to connect a front modular armored panel (not shown). Hinges 417a and 417b may be replaced with any additional fitting mechanisms known to a person skilled in the art. In some embodiments, the front lower recess 418 may be configured to enable at least a portion of a base modular armored panel (not shown) to pass therethrough during the assembly of the modular armor.

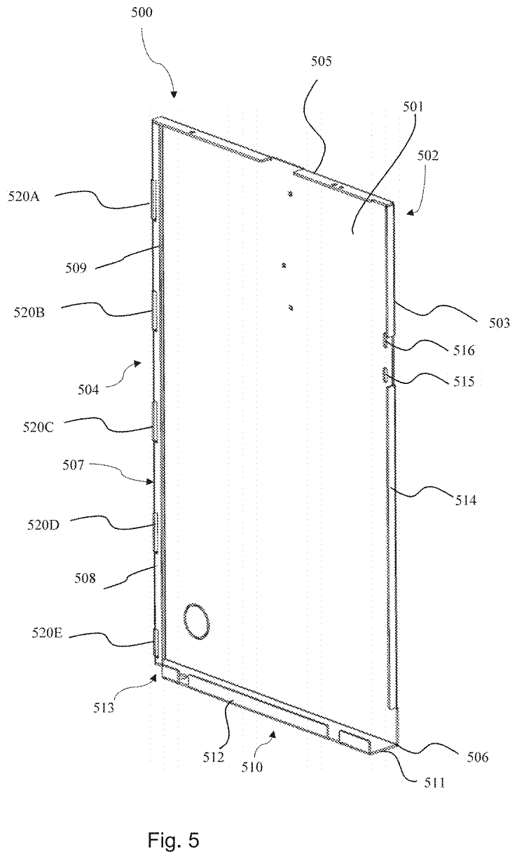

FIG. 5 shows a second side modular armored panel 500 of the modular armor, configured to be placed substantially vertically to the ground. In some embodiments, second side modular armored panel 500 includes a second side inner surface 501, a second side outer surface 502, a second side front edge 503, a second side rear edge 504, a second side top edge 505, and a second side bottom edge 506. In some embodiments, second side rear edge 504 includes a second side rear extension 507 and second side bottom edge 506 includes a second side bottom extension 510. In some cases, second side rear extension 507 second side bottom extension 510 are designed as a mirror image of the rear L-shaped extension and the bottom L-shaped extension of the first side modular armored panel (as shown in FIG. 4).

In some embodiments, second side rear extension 507 protrudes from the entire length of rear edge 504 of the second side modular armored panel 500 and from second side inner surface 501 thereof. Second side rear extension 507 includes a second side rear protrusion element 508 and a second side rear perpendicular element 509. Second side rear protrusion element 508 extends from second side inner surface 501 of second side modular armored panel 500 and at second side rear edge 504 thereof in a substantially perpendicular manner. In some embodiments, second side rear protrusion element 508 extends to a distance from second side modular armored panel 500, that distance being slightly larger than the size of the lateral connectors 310b disposed on the second lateral side of rear modular armored panel 218. Second side rear perpendicular element 509 extends perpendicularly from a distal edge of second side rear protrusion element 508 and towards second side front edge 503. In some embodiments, second side rear perpendicular element 509 extends to a distance from second side rear protrusion element 508, that distance being slightly larger than the width of the lateral connectors 310b disposed on the second side of rear modular armored panel 218.

In some embodiments, a plurality of second side apertures 520a-520e is vertically distributed along the length of second side rear perpendicular element 509. The plurality of second side apertures 520a-520e are configured to receive therethrough a vertical arm and at least a portion of a horizontal arm of the lateral connectors (not shown), which are connected to a rear modular armored panel (not shown), connecting the second side modular armored panel 500 with rear modular armored panel 218. In some embodiments, second side apertures 520a-520e are designed as elongated rectangles. In other embodiments, the plurality of second side apertures 520a-520e may be shaped similarly to a vertical cross section of the lateral connectors 310b disposed on the second lateral side of rear modular armored panel. In some embodiments, the plurality of second side apertures 520a-520e are equally spaced along second side rear perpendicular element 509.

In some embodiments, second side bottom extension 510 protrudes from second side bottom edge 506 of the second side modular armored panel 500. Additionally, second side bottom extension 510 may extend horizontally from second side inner surface 501 of the second side modular armored panel 500 and is configured to be situated adjacently to the ground below the modular armor. In some embodiments, second side bottom extension 510 includes a second side bottom protrusion element 511 and a second side bottom perpendicular element 512. Second side bottom protrusion element 511 extends perpendicularly to second side modular armored panel 500 and adjacent to the ground. In some embodiments, second side bottom protrusion element 511 includes a squared recess in the distal rear corner 513 thereof. The squared recess may be designed to house at least a portion of the bottom protrusion element of rear modular armored panel 300. Second side bottom perpendicular element 512 extends substantially perpendicularly upwards from a distal edge of the second side bottom protrusion element 511 and upwards towards second side top edge 505. In some cases, second side bottom perpendicular element 512 may be parallel to second side inner surface 501 of the second side modular armored panel 500. In some cases, the dimensions of second side bottom extension 510 are identical to the dimensions of the bottom L-shaped extension of the first side modular armored panel, as aforementioned in FIG. 4.

In some embodiments, second side front edge 503 of the second side modular armored panel 500 includes a second side front perpendicular element 514. Front perpendicular element 514 may extend from second side front edge 503 perpendicularly to the second side modular armored panel 500 and from second side inner surface 501 thereof. In some embodiments, second side front perpendicular element 514 defines at least one front recess 515 therein. In such cases, at least one aperture 516 is disposed on the second side modular armored panel 500, and in close proximity to at least one front recess 515. In some embodiments, at least one front recess 515 is configured to accommodate at least a portion of a locking element such as half of a hasp for placing a lock therein. In such cases, the second half is situated on the front modular armored panel (not shown).

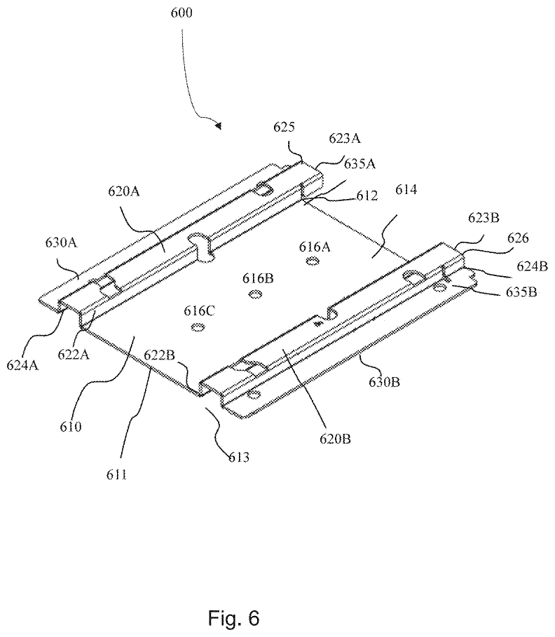

FIG. 6 shows a base modular armored panel of the modular armor, according to exemplary embodiments of the subject matter. FIG. 6 shows a base modular armored panel 600, which is configured to be installed on and to hold together the first side, the second side and the rear modular armored panels. In some embodiments, base modular armored panel 600 is installed on the extensions of the first side, the second side and the rear modular armor panels. Base modular armored panel 600 is designed with at least one aperture therein for allowing at least one ground connector therethrough for connecting base modular armored panel 600 to the ground below the modular armor. In further embodiments, base modular armored panel 600 is designed with at least one additional aperture for allowing at least one connector, which may be ground connector or a connecting element to base modular armored panel 600, arriving from an ATM residing inside the modular armor therethrough for connecting the ATM directly to the ground.

Base modular armored panel 600 includes a base central platform 610, a base first and second elevated platforms 620a and 620b, extending from a first and a second central lateral side of base central platform 610, and a first and a second base intermediate platforms 630a and 630b extending from the elevated platforms 620a and 620b. In some embodiments, central platform 610 is shaped as a rectangle, having a central front edge 611, a central first lateral edge 612, a second central lateral edge 613 and a rear edge 614. In some embodiments, central platform 610 may include at least one aperture disposed therein. In some cases, central platform 610 includes three apertures 616a, 616b and 616c, for receiving therethrough and accommodating therein ground connectors for connecting base modular armored panel 600 to the ground below the modular armor. In some embodiments of the invention, the length of central platform 610 is about the length of rear modular armored panel 300 minus twice the distance X of the two extensions of first side and second side modular armored panels.

In some embodiments, a first elevated platform 620a is connected to first central lateral edge 612 of central platform 610 by a first proximal perpendicular wall 622a. A second elevated platform 620b is connected to second central lateral edge 613 of central platform 610 with a second proximal perpendicular wall 622b. In some embodiments, first and second proximal perpendicular walls 622a and 622b extend just above the distance Y of the bottom perpendicular elements of first, second and rear modular armored panels. In some embodiments, elevated platforms 620a and 620b are attached to a first and second elevated extension 623a and 623b, respectively, extending beyond rear edge 614 of central platform 610. In such case, first and second elevated extensions 623a and 623b may have a length that is about the length of the bottom extension of rear modular armored panel 300. In some embodiments, first and second elevated platforms 620a and 620b are identical to each other. In other embodiments, first and second elevated platforms 620a and 620b are mirror image of each other. In some embodiments, first and second elevated platforms 620a and 620b and the first and second elevated extensions 623a and 623b are formed with a smooth texture, configured to ease sliding devices, such as ATMs, thereon. In some embodiments, each of first and second elevated platforms 620a and 620b may include at least one aperture disposed thereon. In such cases, the at least one aperture disposed thereon may be used for fitting at least a portion of the ATM therethrough. In other embodiments, at least one aperture may be used for passing therethrough and accommodating therein connectors for connecting the ATM through the first and second elevated platforms 620a and 620b to the ground below the modular armor.

In some embodiments, the first elevated platform 620a is connected to a first intermediate platform 630a by a first remote perpendicular wall 624a extending from a first elevated remote edge 625 thereof. The second elevated platform 620b is connected to a second intermediate platform 630b by a second remote perpendicular wall 624b extending from a second elevated remote edge 626 thereof. First and second remote perpendicular walls 624a and 624b are extending perpendicularly downwards from remote edges 615 and 616 of first and second elevated platforms 620a and 620b. In some embodiments, first and second remote perpendicular walls 624a and 624b are parallel to first and second proximal perpendicular walls 622a and 622b. In some embodiments, the height of the first and second remote perpendicular walls 624a and 624b may be smaller than distance Y, and in further embodiments is about Y minus the width of the bottom protrusion element. The height of first and second remote perpendicular walls 624a and 624b is designed to bring first and second intermediate platforms 630a and 630b to be in contact with bottom protrusion elements 411, 511 of first side and second side modular armored panels 400, 500, respectively.

In some embodiments, first and second intermediate platforms 630a and 630b include at least one aperture for allowing ground connectors to pass therethrough and to accommodate the ground connector therein. In some embodiments, first intermediate platform 630a is positioned above bottom protrusion element 411 of first side modular armored panel 400 and second intermediate platform 630b is positioned above bottom protrusion element 511 of second side modular armored panel 500. In further embodiments, at least one aperture in the first intermediate platform 630a is positioned above at least one aperture in bottom protrusion element 411 of first side modular armored panel 400. Additionally, the at least one apertures in second intermediate platform 630b may be positioned above at least one aperture in bottom protrusion element 511 of the second side modular armored panel 500. In such cases, the ground connector that passes through the at least one aperture in first and second intermediate platforms 630a and 630b and into the ground below the modular armor, also passes through the at least one aperture in bottom protrusion elements 411, 511, of first side and second side modular armored panels 400, 500, respectively. Thus, by accommodating the ground connector through the at least one aperture in first and second intermediate platforms 630a and 630b, the modular armor is secured to the ground and the base modular armored panel secures the first side, second side and rear modular armored panels. In some embodiments, the ground connectors may be anchor bolts. In other embodiments, the ground connectors may be screws that are configured to be connected to matching threaded bores beneath the modular armor.

In some embodiments, a first slot 635a extends through the first proximal perpendicular wall 622a and through the first remote perpendicular wall 624a. Additionally, a second slot 635b extends through the second proximal perpendicular wall 622b and through the second remote perpendicular wall 624b. In some embodiments, the first slot 635a and the second slot are situated along an axis, extending beyond rear edge 614 and in parallel thereto, and is further perpendicular to the first and second elevated platform 620a and 620b. In some embodiments, the first and second slots 635a and 635b are dimensioned to receive therein a portion of the bottom perpendicular element (such as the bottom perpendicular element 309 of FIG. 3) of a bottom extension of the rear panel. Thus, first and second slots 635a and 635b are configured to secure rear modular armored panel 300 to the ground.

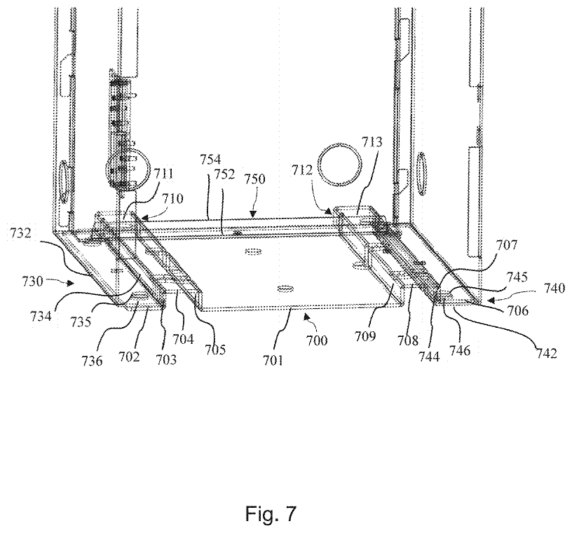

FIG. 7 shows the base modular armored panel of FIG. 6, installed on the bottom extensions of the front side modular armored panel of FIG. 4, second side modular armored panel of FIG. 5 and rear modular armored panel 300 of FIG. 3, according to exemplary embodiments of the subject matter. A base modular armored panel 700 is located on a first side bottom extension 730 belonging to a first side modular armored panel, on a second side bottom extension 740 and on a rear bottom extension 750 belonging to rear modular armored panel 300. As shown, a central platform 701 is placed on the same plane with three bottom protrusion elements 732, 742 and 752 of bottom extensions 730, 740 and 750. As mentioned, with reference to FIGS. 3 to 5, each of bottom extensions 730, 740 and 750 including bottom protrusion elements 732, 742 and 752 and bottom perpendicular elements 734, 744 and 754. In some embodiments, first side bottom protrusion element 732 of first side bottom extension 730 is installed underneath a first intermediate platform 702 of base modular armored panel 700. In some embodiments, first side bottom perpendicular element 734 is disposed in a space defined between a first remote perpendicular wall 703, a first elevated platform 704 and a first proximal perpendicular wall 705. In some embodiments, first side bottom perpendicular element 734 is designed to be in close proximity to first remote perpendicular wall 703. In such cases, at least one aperture 735 in first intermediate platform 702 is located above at least one aperture 736 in first side bottom protrusion element 732. Thus, a ground connector may be inserted to and be accommodated in at least one aperture 735, at least one aperture 736 and the ground below the modular armor.

In some embodiments, a second side bottom protrusion element 742 of second side bottom extension 740 is installed underneath a second intermediate platform 706 of base modular armored panel 700. In some embodiments, a second side bottom perpendicular element 744 of second side bottom extension 740 resides in a space defined by a second remote perpendicular wall 707, a second elevated platform 708 and a second proximal perpendicular wall 709. In some embodiments, second side bottom perpendicular element 744 is designed to be in close proximity to second remote perpendicular wall 707 of base modular armored panel 700. In such cases, at least one aperture 745 in second intermediate platform 706 is located above at least one aperture 746 in second side bottom protrusion element 742. Thus, a ground connector may be inserted into at least one aperture 745, at least one aperture 746 and the ground below the modular armor.

In some embodiments, rear bottom perpendicular element 754 of rear bottom protrusion element 750 is designed to be inserted into a first slit 710 located between first elevated platform 704 and a first elevated extension 711. Additionally, rear bottom perpendicular element 754 is designed to be inserted into a second slit 712 located between second elevated platform 708 and a second elevated extension 713. In some embodiments, rear bottom perpendicular element 754 is designed to be in contact with the rear edge of central platform 701 when base modular armored panel 700 is installed thereon. In such cases, first and second elevated extensions 711 and 713 are placed above a rear bottom protrusion element 752 of rear bottom extensions 750. Thus, rear modular armored panel is secured to base modular armored panel 700. In some embodiments, the first side, second side and the rear bottom protrusion elements are located throughout their entire length on the same plane.

In some embodiments, all the apertures disposed in base modular armored panel 700 and bottom extensions 730, 740 and 750 have a similar diameter. In some embodiments, the aforementioned diameter is designed to accommodate a ground connector such as an anchor bolt. In some embodiments, the apertures located on the elevated platform may include a larger diameter to accommodate a larger ground connector.

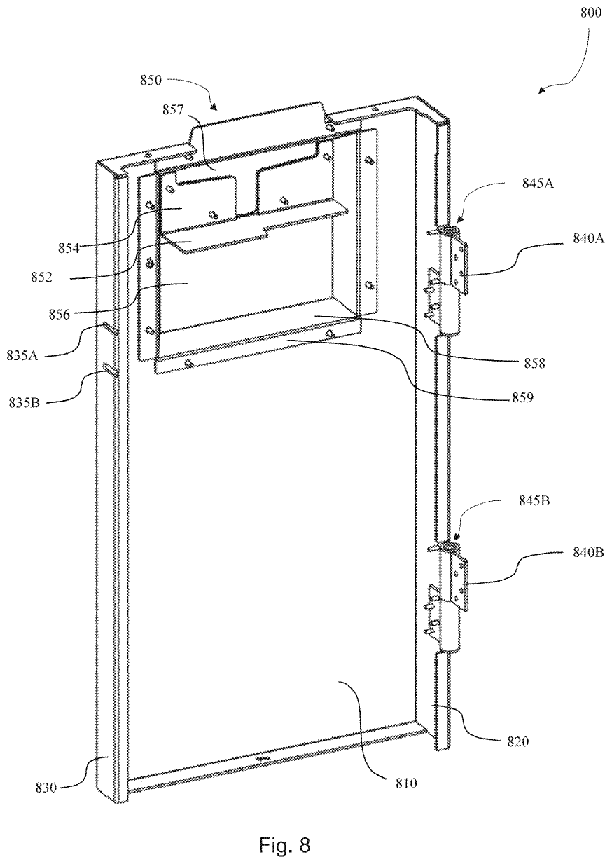

FIG. 8 shows a front modular armored panel 800 including a front inner surface 801 and a front outer surface 802. Front modular armored panel 800 is formed from a single plate of uniform thickness. Front modular armored panel 800 is configured to serve as an openable door to the modular armor. As such, front modular armored panel 800 is configured to be connected to one of the side modular armored panels, and to be releasably secured to the other side modular armored panel.

Front modular armored panel 800 includes a front central panel 810 including a first side front extension 820 and a second side front extension 830. First side front extension 820 extends perpendicularly from a first lateral edge 811 and from front inner surface 801 of front modular armored panel 800. Additionally, second side front extension 830 extends perpendicularly from a second lateral edge 812 and from front inner surface 801 of front modular armored panel 800. In some embodiments, first and second side front extensions 820 and 830 have the same length. In some embodiments, the length of one of first and second side front extensions 820 and 830 are larger than the other in order to allow the safe door of the ATM to be fully opened when front modular armored panel 800 is opened. In some cases, first side front extension 820 is larger than second side front extension 830. In some embodiments, first side front extension 820 are rotatably connected to the first side modular armored panel by at least one hinge disposed in at least one recess in first side front extension 820. The at least one hinge may be an upper hinge 840a and a lower hinge 840b disposed in an upper recess 845a and a lower recess 845b in first side front extension 820.

In some embodiments, second side front extension 830 includes at least one aperture. In some embodiments, at least one aperture is a first aperture 835a and second aperture 835b, disposed vertically to each other. First aperture 835a and second aperture 835b are designed to receive connectors therethrough for securing at least a portion of a locking element, which is configured to be secured to second side front extension 830. In some embodiments, the locking element is further configured to be secured to the second side modular armored panel. In some embodiments, the locking element is a hasp for a lock. In such cases, half a hasp is disposed on second side front extension 830 by connectors accommodated in first and second apertures 835a and 835b, and half a hasp is disposed on the second side modular armored panel.

Front modular armored panel 800 includes a cash interface reinforcing mechanism 850 situated in an opening (not shown) disposed in front central panel 810 of front modular armored panel 800. In some embodiments, cash interface reinforcing mechanism 850 is designed to allow a secured access to the cash exchange mechanism (not shown) of the ATM residing inside the modular armor. In some embodiments, cash interface reinforcing mechanism 850 includes a shelf 852, which separates the cash interface reinforcing mechanism 850 into a cash exchange portion 854 and an accommodation portion 856. Cash interface reinforcing mechanism 850 defines a T-shaped aperture 857, designed to enable users to pick up cash or other goods delivered by the ATM in cash exchange portion 854. Additionally, cash interface reinforcing mechanism 850 includes an elevating wall 858, designed to elevate cash interface reinforcing mechanism 850 from front central panel 810. Additionally, elevating wall 858 produces a space, which allows cash to be delivered and stacked horizontally and also serves to increase the distance between the cash exchange mechanism of the ATM and the users. Elevating wall 858 of cash interface reinforcing mechanism 850 is perpendicularly bent at a distal portion 859 thereof, enabling distal portion 859 to be attached by connectors to front inner surface 801 of front central panel 810.

In some embodiments, front nodular armored panel 800 may include additional apertures or recesses similar to accommodation portion 856, for accommodating projections or other assemblies associated with the ATM residing inside the modular armor, as each model of an ATM be arranged slightly differently, resulting in a different front modular armored panel 800 with different dimensions, cutouts, and projections.

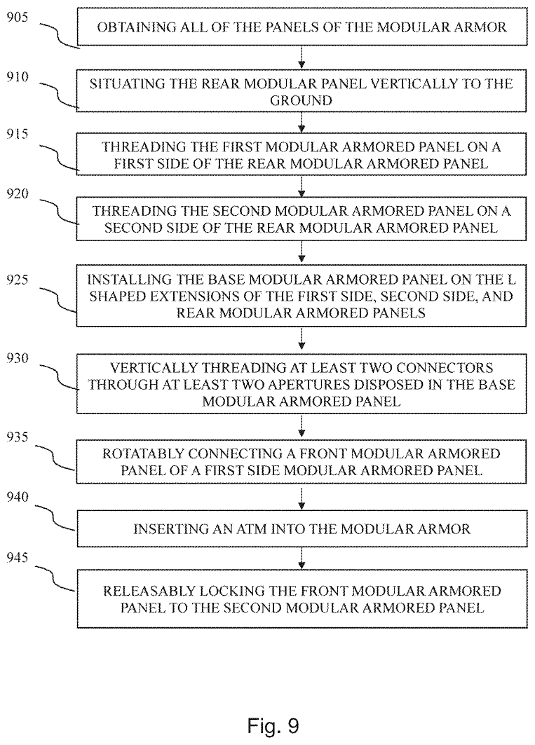

FIG. 9 depicts a method for assembling modular ATM armor, according to embodiments of the subject matter. In step 905, all the panels of the modular armor are obtained. In some embodiments, the panels include: a first side modular armored panel, a second side modular armored panel, a rear modular armored panel, a base modular armored panel and a front modular armored panel. In step 910, the rear modular armored panel is situated vertically on the ground. In cases where the ground is a sturdy component, such as concrete, a ground connector (such as anchor bolt) may be secured thereto. In some embodiments, rear modular armored panel is placed with the outer surface thereof in close proximity to or in contact with a wall.

In step 915, the first side modular armored panel is threaded by the apertures on the rear extension thereof on first side lateral connectors 310a, located on a first lateral side of rear modular armored panel. In some embodiments, first side lateral connectors 310a face downward. In such cases, the threading includes securing the vertical portion of first side lateral connectors 310a inside the apertures. For example, rear modular armored panel is pushed downwards, thus securing first side lateral connectors 310a in a space between the perpendicular element and the inner surface of the rear modular armored panel and partly below the apertures.

In step 920, the second side modular armored panel is threaded by the apertures on the rear extension thereof on the second side lateral connectors 310b, located on a second lateral side of rear modular armored panel. In some embodiments, second side lateral connectors 310b face upwards. In such a case, the threading secures the vertical portion of first side lateral connectors 310a inside the apertures. For example, after the apertures of the second side modular armored panel pass the vertical arm of first side lateral connectors 310a, the second side modular armored panel is pushed downwards, thus securing second side lateral connectors 310b in a space between the perpendicular element and the inner surface of the rear modular armored panel, and partly above the apertures.

In step 925 the base modular armored panel is installed on the protrusion elements of the first side, the second side and the rear modular armored panels. The installation includes placing the first intermediate platform of the base modular armored panel on the first side bottom protrusion element and inserting the first side bottom perpendicular element into a space beneath the first elevated portion of the base modular armored panel. The installation further includes placing the second intermediate platform of the base modular armored panel on the second side bottom protrusion element and inserting the second side bottom perpendicular element into a space beneath the second elevated portion of the base modular armored panel. The installation also includes placing the first and second slots of the base modular armored panel on the rear bottom perpendicular element, thus bringing the elevated extensions of the base modular armored panel above, and in parallel to the rear bottom protrusion element.

In step 930, at least two ground connectors are vertically threaded through at least two apertures in the base modular armored panel. In some cases, at least one ground connector is threaded through at least one aperture disposed on the first intermediate platform of the base modular armored panel, through at least one matching aperture disposed on the first side bottom protrusion element and into the ground. Additionally, at least one ground connector is threaded through at least one aperture disposed on the second intermediate platform of the base modular armored panel, through at least one matching aperture disposed on the second side bottom protrusion element and into the ground. Additional bolts may be threaded through apertures located on the central platform of the base modular armored panel. In an optional embodiment, the modular armor is further secured by threading at least one ground connector through an aperture located in rear modular armored panel and into a wall situated behind the rear modular armored panel.

In step 935, a front modular armored panel is connected to one of the side modular armored panels. In some embodiments, the front modular armored panel is connected to the first side modular armored panel via hinges. In step 940, an ATM is situated inside the modular armor. The ATM may be slid, backside first, on the smooth top of the elevated platforms of the base modular armored panel until the ATM is fully situated on the base modular armored panel. In step 945, the front modular armored panel is releasably secured to the second side modular armored panel by a locking element. In some cases, the locking element is situated on both the front modular armored panel and the second side modular armored panel.

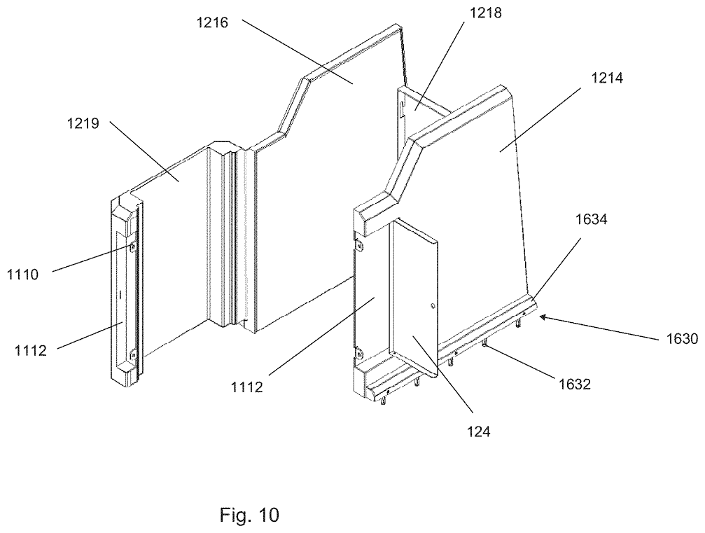

FIG. 10 shows an embodiment of an anti-theft ATM casing 1210 wherein the casing is configured so that it is installable around a fixed ATM 1000; i.e. an ATM that is not mobile, or at least not necessarily mobile, meaning the ATM is not inserted/slid/rolled into the casing. Casing 1210 includes a plurality of anti-theft panels, in particular, a right side panel 1214; a left side panel 1216; a rear panel 1218; and a “closable door” panel or front panel 1219, which is configured to act as a closure panel. Such a design obviates the need to slide ATM 1000 into the ATM armor or casing 1210 and allows the ATM to be fixed to the ground, or a floor or the like,

Herein the specification and claims, the terms “ground” and “floor”, and derivatives thereof, are used interchangeably to denote any surface upon which ATM 1000 may be located.

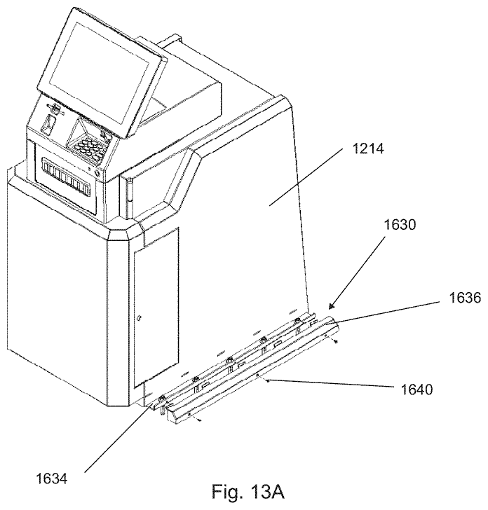

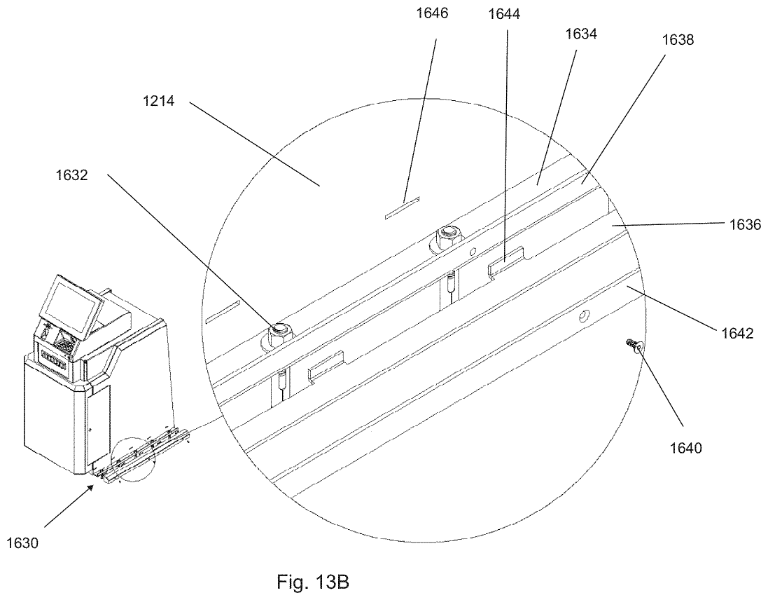

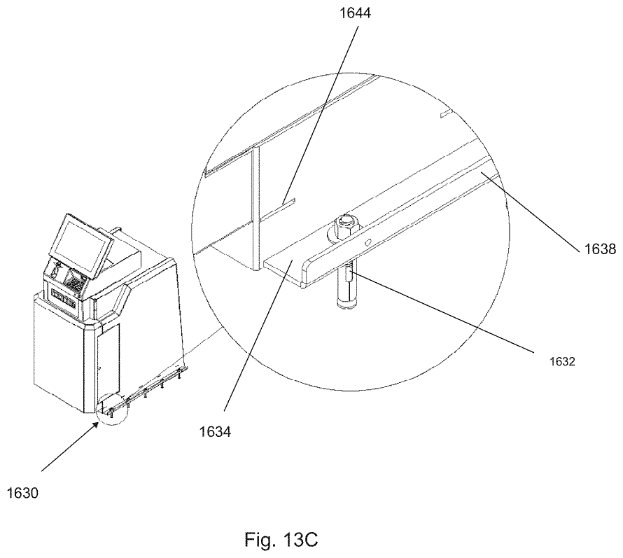

ATM 1000 includes a casing anchoring mechanism 1630. Casing anchoring mechanism 1630 includes a plurality of casing-to-ground anchor bolts 1632 and an anchoring flange 1634 to connect ATM casing 1210 to the ground. Details of ATM casing anchoring mechanism 1630 are described below with reference to FIGS. 13A-13C.

ATM casing 1210 has locking elements 1110, which may be constituted by corresponding eyebolt like elements, as illustrated, configured to be locked to each other by a padlock (not shown) or the like. Locking elements 1110 may be located in corresponding locking element recesses 1112 of corresponding edge portions in a forward portion of right side panel 1214 and of front panel 1219, as illustrated.

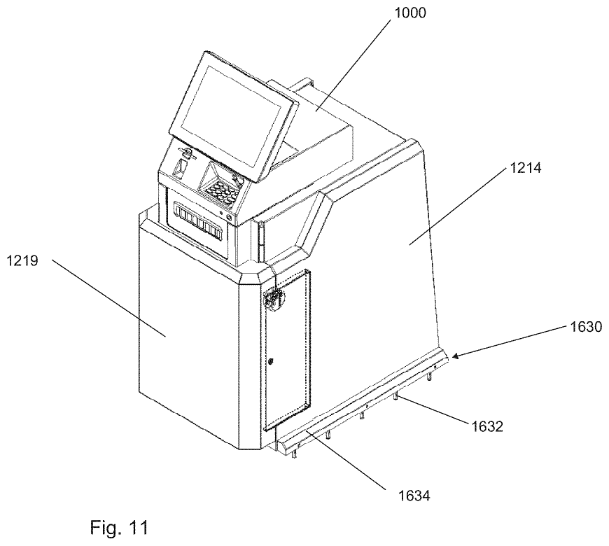

FIG. 11 shows ATM 1000 with ATM casing 1210 installed there-around. Casing 1210 is configured to provide at least a portion of ATM 1000 with protection from tampering, in particular to mitigate the chances of access to safe portion 120 (FIG. 1).

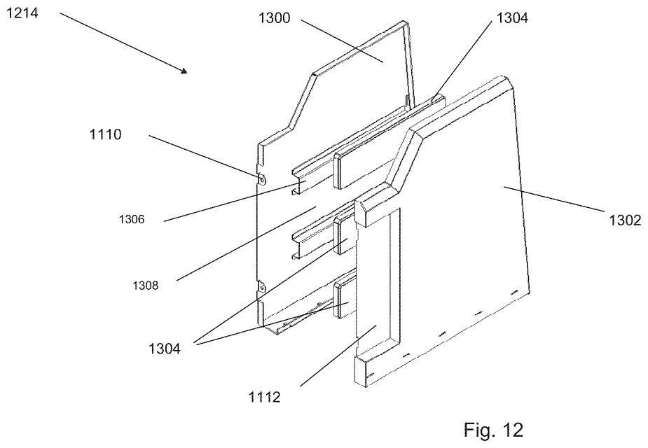

FIG. 12 illustrates an exemplary structure of right side panel 1214 having an inner wall 1300 and an outer wall 1302 defining a hollow space there-between. The other panels may, and preferably do, have a similar structure. The panels are preferably reinforced, as noted with reference to FIG. 8. As such, right side panel 1214 (and any or all of the casing panels), may include at least one reinforcement plank 1304 (three illustrated), made of any suitably sturdy material. Planks 1304 may be adhered to the panel(s) by a variety of means, including by an adhesive or using one or more fasteners, or the like. In a particular embodiment, plank 1304 is associated with or attached to one or more of the panels, such as right side panel 1214, via one or more plank holders 1306. Planks 1304 may be attached to plank holders 1306 or disposed between spaced apart plank holders, fitting into a plank receiving space 1308, as illustrated. Plank holders 1306 themselves may be configured to provide strength to the panels so as to further reinforce the panels. It should be noted that each of the panels may be formed as a single wall, with or without reinforcement means (planks, beams, etc.).

FIGS. 13A-13C show greater detail of an exemplary embodiment of casing anchoring mechanism 1630. As noted above, casing anchoring mechanism 1630 includes casing-to-ground anchor bolts 1632 and anchoring flange 1634. Mechanism 1630 also includes a non-tamper or protective anchor cover 1636, which is configured to prevent or at least reduce access to the anchor bolts to help counteract removal of ATM 1000. During attachment of the ATM casing to the ground, anchor bolts 1632 are threaded/inserted in through-holes in anchoring flange 1634; and bolted to the ground.

Anchor cover 1636 can be attached to anchoring flange 1634, which can be L-shaped for such purpose, at a generally vertical outer strip 1638 of the flange, such as by fasteners 1640, or by a hinge (not shown) to allow pivoting. Outer strip 1638 may be connected to a downwardly facing anchor cover strip 1642. Inner cover tabs 1644 of anchor cover 1636 may first (or subsequently, depending on the particular design) be inserted into corresponding cover tab receiving slits 1646, located near the lower edge of the panels, as illustrated with reference to right side panel 1214.

It should be understood that the above description is merely exemplary and that there are various embodiments of the present invention that may be devised, mutatis mutantis, and that the features described in the above-described embodiments, and those not described herein, may be used separately or in any suitable combination; and the invention can be devised in accordance with embodiments not necessarily described above.

1. An ATM casing comprising:
casing panels including a front panel; a rear panel; a right side panel; and a left side panel, wherein the rear panel has a right lateral edge and a left lateral edge; the right side panel has a rear lateral edge; the left side panel has a rear lateral edge; and the front panel has a right lateral edge configured to pivotably connect to the right lateral edge of the right side panel; and the front panel has a left lateral edge configured to reversibly and lockably connect with the left lateral forward edge of the left side panel;
lateral connectors (a) disposed at the right lateral edge of the rear panel and at the rear lateral edge of the right side panel, and which correspond to and are configured to reversibly connect there-between; and (b) disposed at the left lateral edge of the rear panel and at the rear lateral edge of the left side panel, which correspond to and are configured to reversibly connect there-between;
locking elements disposed at the left lateral edge of the front panel and at the front lateral edge of the left side panel to facilitate locking there-between; and
a plurality of casing anchor bolts configured to secure the ATM casing to the ground,
wherein at least one of (i) the rear panel, (ii) the right side panel; and (iii) the left side panel comprises an ATM casing anchoring mechanism comprising an anchoring flange extending from a bottom portion of at least one of (i) the rear panel, (ii) the right side panel; and (iii) the left side panel and configured to receive the plurality of casing anchoring bolts; and an anchoring flange cover, configured to prevent access to the plurality of casing anchor bolts.

2. The casing of claim 1, wherein the ATM casing anchoring mechanism is integrally formed with at least one of the rear panel, the right side panel; and the left side panel.

3. The casing of claim 1, wherein the anchoring flange of ATM casing anchoring mechanism is integrally formed with at least one of (i) the rear panel, (ii) the right side panel; and (iii) the left side panel.

4. The casing of claim 4, wherein the anchoring flange of ATM casing anchoring mechanism is integrally formed with the right side panel; and (in) the left side panel.

5. The casing of claim 1, wherein the front panel and a forward portion of the right side panel each comprises a recess configured to house corresponding portions of the locking elements.

6. The casing of claim 1, wherein at least one of (i) the rear panel, (ii) the right side panel; and (in) the left side panel comprises an inner wall and an outer wall with a hollow space there-between.

7. The casing of claim 6, wherein within at least one of the hollow spaces there is located at least one of reinforcement plank.

8. The casing of claim 7, wherein within at least one hollow space there is at least one plank is associated with, or attached to, one or more of the panels via one or more plank holders.

9. The casing of claim 8, wherein the planks are disposed between spaced apart the plank holders in a plank receiving space.
